(19) United States
(12) Patent Application Publication
(10) Pub. No.: US 2026/0010658 A1
(43) Pub. Date: Jan. 8, 2026

(54) INFORMATION PROCESSING APPARATUS TO VERIFY FALSIFICATION OF DATA, CONTROL METHOD THEREFOR, AND STORAGE MEDIUM STORING CONTROL PROGRAM THEREOF

(71) Applicant: CANON KABUSHIKI KAISHA, Tokyo (JP)

(72) Inventor: Daiyu UENO, Tokyo (JP)

(21) Appl. No.: 19/246,777

(22) Filed: Jun. 24, 2025

(30) Foreign Application Priority Data
Jul. 8, 2024 (JP) 2024-109453

(51) Int. Cl. G06F 21/64; H04L 9/32

(52) U.S. Cl. CPC G06F 21/64; H04L 9/3236; H04L 9/3247

(57) ABSTRACT

An information processing apparatus capable of improving usability in verification of falsification of moving image data. The information processing apparatus including a memory device and a processor that executes instructions in the memory device to obtain a moving image file including moving image data constituted by frames, a first-type hash value generated by executing a hash function on whole moving image data, and second-type hash values generated by executing the hash function on frame groups, execute a first process of detecting falsification of the moving image data by using the first-type hash value, and control whether to execute a second process to detect falsification of the moving image data by using the second-type hash values when falsification is detected in the first process.

### BACKGROUND

### FIELD OF THE TECHNOLOGY

The present disclosure relates to an information processing apparatus to verify falsification of data, a control method therefor, and a storage medium storing a control program therefor.

### DESCRIPTION OF THE RELATED ART

In recent years, information sharing via the Internet has been actively performed, and anyone can disclose and transmit various information to unspecified persons. Further, a digital image can be processed in various ways. In such a situation, information may originate from an unreliable source, or information that is publicly available may have been falsified illegally. In contrast, a technique to verify falsification of data is proposed in Japanese Patent Publication No. 2007- 336457. The technique in this publication searches a file group for files to be verified and displays both progress of the file search and progress of verification of falsification using a hash value.

Moreover, when falsification of moving image data including a plurality of frames is verified, a plurality of hash values generated by executing a hash function on frame groups are used. Each of the frame groups is obtained by grouping a plurality of frames constituting the moving image data in capturing the moving image data. This enables to not only determine whether the moving image data has been falsified but also specify a falsified frame in the moving image data.

However, when a hash value is generated for each frame group as described above, the number of hash values increases by the number of frame groups, which increases the time required for verification and decreases usability.

### SUMMARY

The present disclosure provides an information processing apparatus, a control method therefor, and a storage medium storing a control program therefor, which are capable of improving usability in verification of falsification of moving image data. Verification of falsification may involve determining whether moving image data has been altered (i.e. the image content of the moving image data altered).

Accordingly, an aspect of the present disclosure provides an information processing apparatus including a memory device that stores a set of instructions, and at least one processor that executes the set of instructions to obtain a moving image file including moving image data constituted by frames, a first-type hash value generated by executing a hash function on whole moving image data when the moving image data is captured, and second-type hash values generated by executing the hash function on frame groups obtained by grouping the frames of the moving image data when the moving image data is captured, execute a first process of detecting falsification of the moving image data by using the first-type hash value, determine whether falsification of the moving image data is detected in the first process, and control whether to execute a second process to detect falsification of the moving image data by using the second-type hash values when it is determined that falsification of the moving image data is detected in the first process.

Features of the present disclosure will become apparent from the following description of embodiments with reference to the attached drawings. The following description of embodiments are described by way of example.

### BRIEF DESCRIPTION OF THE DRAWINGS

FIG. 1A is a front perspective view illustrating an external appearance of a digital camera as an information processing apparatus according to an embodiment.

FIG. 1B is a rear perspective view illustrating the external appearance of the digital camera in FIG. 1A.

FIG. 2 is a block diagram illustrating a configuration example of the digital camera in FIG. 1A.

FIG. 3 is a flowchart illustrating procedures of a main process executed by the digital camera in FIG. 1A.

FIG. 4 is a flowchart illustrating procedures of a still image capturing process in S305 in FIG. 3.

FIG. 5A is a view illustrating an example of a configuration of a still image file generated by the digital camera in FIG. 1A.

FIG. 5B is a view illustrating an example of a configuration of a moving image file generated by the digital camera in FIG. 1A.

FIG. 6 is a flowchart illustrating procedures of a moving image capturing process in S307 in FIG. 3.

FIG. 7 is a flowchart illustrating procedures of a verification process in S309 in FIG. 3.

FIG. 8A is a view illustrating an example of a folder selection screen displayed on a display unit in the verification process in FIG. 7.

FIG. 8B is a view illustrating an example of a condition designation screen displayed on the display unit in the verification process in FIG. 7.

FIG. 8C is a view illustrating an example of a whole verification ongoing screen displayed on the display unit in the verification process in FIG. 7.

FIG. 8D is a view illustrating an example of a whole verification completion screen displayed on the display unit in the verification process in FIG. 7.

FIG. 9A is a view illustrating an example of a moving-image individual verification screen displayed on the display unit in the verification process in FIG. 7.

FIG. 9B is a view illustrating an example of an individual verification ongoing screen displayed on the display unit in the verification process in FIG. 7.

FIG. 9C is a view illustrating an example of an individual verification completion screen displayed on the display unit in the verification process in FIG. 7.

FIG. 9D is a view illustrating an example of a detail check screen displayed on the display unit in the verification process in FIG. 7.

FIG. 10 is a flowchart illustrating procedures of a whole verification process in S703 in FIG. 7.

FIG. 11 is a flowchart illustrating procedures of an individual verification process in S712 in FIG. 7.

### DESCRIPTION OF THE EMBODIMENTS

Hereinafter, embodiments of the present disclosure will be described below with reference to drawings. The embodiments to be described below are examples, and may be appropriately modified for implementation by those skilled in the art without departing from the scope of the invention as defined by the appended claims. Each of the embodiments of the present invention described below can be implemented solely or as a combination of a plurality of the embodiments or features thereof where necessary or where the combination of elements or features from individual embodiments is beneficial. A plurality of features are described in the embodiments, but not all the plurality of features are always essential to the invention. The plurality of features can also be arbitrarily combined.

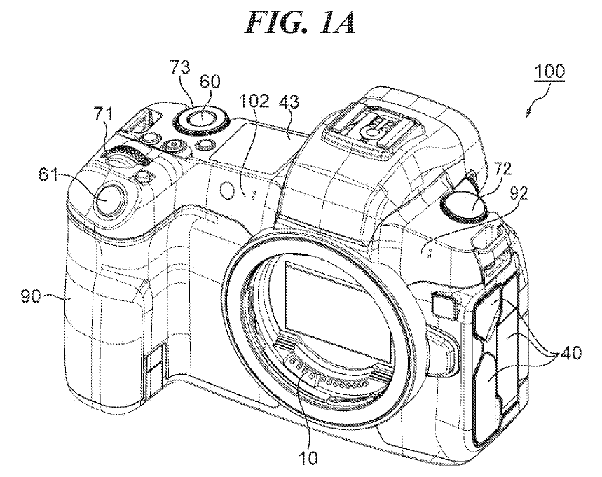

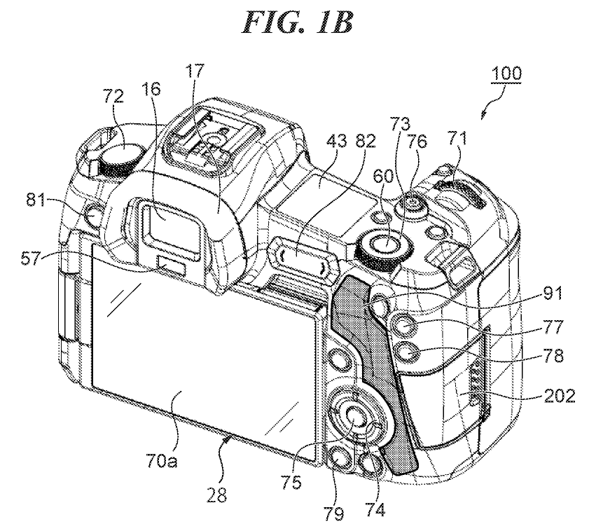

FIG. 1A and are perspective views illustrating an external appearance of a digital camera 100 as an information processing apparatus (an image capturing apparatus) according to an embodiment. is a front perspective view of the digital camera 100, and is a rear perspective view of the digital camera 100.

A back-face display unit 28 is a display unit provided on a back surface of the digital camera 100 and displays an image and various kinds of information. The touch panel 70a detects a touch operation on a display surface (touch operation surface) of the back-face display unit 108. An upper-face display unit 43, which is a display unit outside a viewfinder, is provided on an upper surface of the digital camera 100, and displays various set values of the digital camera 100 including a shutter speed and an aperture value.

A shutter button 61 is an operation member configured to give an image capturing instruction. A mode changeover switch 60 is an operation member for switching a mode among various modes. A terminal cover 40 is a cover for protecting a connector (not shown) to which a connection cable for connecting the digital camera 100 to an external apparatus is connected. A main electronic dial 71 is a rotation operation member. By turning the main electronic dial 71, a set value such as the shutter speed or the aperture value can be changed. A power switch 72 is an operation member for switching the power of the digital camera 100 between ON and OFF. A sub electronic dial 73 is a rotary operation member. By turning the sub electronic dial 73, a selection frame (cursor) is moved or images are fed.

A four-direction key 74 is configured such that upper, lower, left, and right portions thereof can be pressed, and a process corresponding to a pressed portion of the four-direction key 74 can be executed. A set button 75 is a push button and is mainly used for fixing a selection item.

A moving image button 76 is used to instruct start or stop of moving image capturing (recording). An AE lock button 77 is a push button. The user can fix an exposure state by pressing the AE lock button 77 in a capturing standby state.

An enlargement button 78 is an operation button for switching between ON and OFF of an enlargement mode for live view display (LV display) in an image capturing mode. By operating the main electronic dial 71 after setting the enlargement mode to ON, a live view image (LV image) is enlarged or reduced.

In a playback mode, the enlargement button 78 functions as an operation button for enlarging a playback image or increasing an enlargement ratio. A playback button 79 is an operation button for switching between the image capturing mode and the playback mode. When a user presses the playback button 79 in the image capturing mode, the mode is shifted to the playback mode, and the latest image among images recorded in a recording medium 200, which is described later, can be displayed on the back-face display unit 28.

A menu button 81 is a push button used to perform an instructing operation for displaying a menu screen. When the menu button 81 is pushed, the menu screen on which various settings are possible is displayed on the back-face display unit 28. The user can intuitively perform various settings by operating the four-direction key 74 and the SET button 75 while viewing the menu screen displayed on the back- face display unit 28.

A touch bar 82 (also referred to as multifunction bar: M-Fn bar) is a linear touch operation member (line touch sensor) capable of accepting a touch operation. The touch bar 82 is disposed at a position where the touch bar 82 can be touched by a thumb of a right hand in a state where a grip portion 90 is gripped by the right hand (in a state where the grip portion 90 is gripped by the little finger, the ring finger, and the middle finger of the right hand) so that the shutter button 61 can be pressed by the index finger of the right hand. That is, the touch bar 82 is disposed at the position so as to be operated in a state (capturing posture) where the user looks into a finder by contacting an eye to an eyepiece unit 16 and can presses the shutter button 61 at any time.

The touch bar 82 is an accepting member capable of accepting a tap operation (an operation of touching and releasing within a predetermined period without moving a finger), a slide operation (an operation of touching and moving a touch position without releasing a finger) to the left or right, and the like. The touch bar 82 is an operation member different from the touch panel 70a, and does not have a display function.

A communication terminal 10 is used for the digital camera 100 to communicate with a lens unit 150 described later. An eyepiece window 16 is a part of an eyepiece finder 17 (a look-in type finder). The user can visually recognize an image displayed on an internal EVF (Electronic View Finder) 29 through the eyepiece window 16.

An eye contact detector 57 is an eye contact detection sensor that detects whether the eye of the user (photographing person) contacts the eyepiece window 16. A lid 202 is a cover of a slot for storing the recording medium 200 described later. The grip portion 90 is a holding portion having a shape that is easy for the user to grip with the right hand when holding the digital camera 100. The shutter button 61 and the main electronic dial 71 are disposed at positions where they can be operated by the index finger of the right hand in the state where the digital camera l 00 is held by gripping the grip portion 90 with the little finger, the ring finger, and the middle finger of the right hand. In the same state, the sub electronic dial 73 and the touch bar 82 are disposed at positions where they can be operated by the thumb of the right hand.

The thumb rest portion 91 (thumb standby position) is a gripping type member provided at a position where the thumb of the right hand gripping the grip portion 90 is easily placed in a state where none of the operation members of the back-face side of the digital camera 100 is operated. The thumb rest portion 91 is formed of a rubber member for enhancing a holding force (a grip feeling).

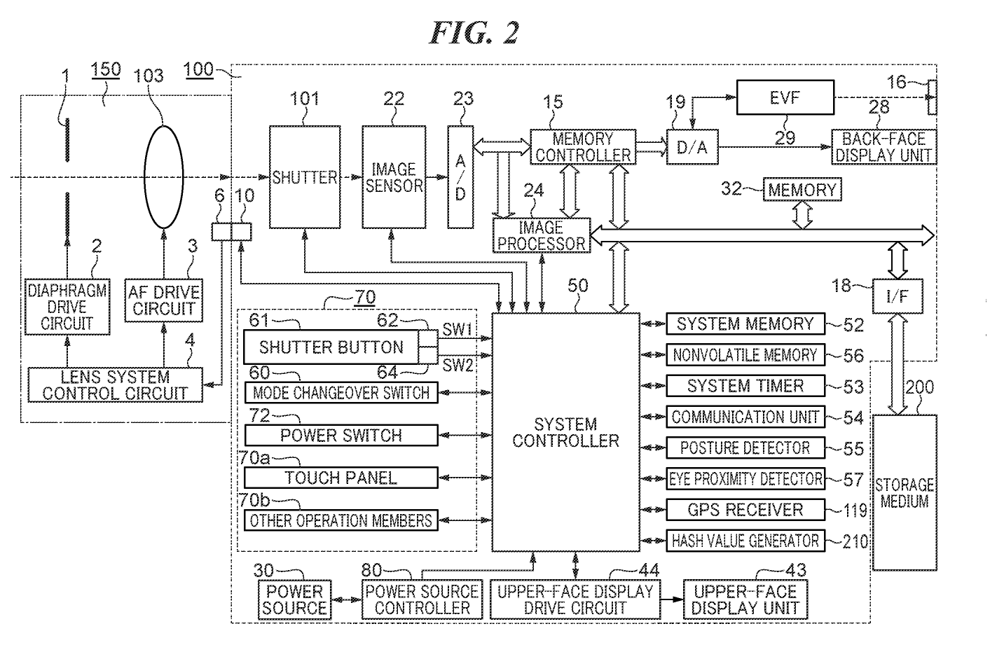

FIG. 2 is a block diagram illustrating a configuration example of the digital camera 100 in FIG. 1A An interchangeable lens unit 150 in which an image capturing lens is mounted is detachable from the digital camera 100. Although a lens 103 is generally constituted by a plurality of lenses, a single lens is shown in for simplicity. A communication terminal 6 of the lens unit 150 is connected with the communication terminal 10 of the digital camera 100 to enable communication between the lens unit 150 and the digital camera 100.

The lens unit 150 communicates with the system controller 50 via these communication terminals 6 and 10. A lens system control circuit 4 inside the lens unit 150 controls a diaphragm 1 via a diaphragm drive circuit 2. The lens system control circuit 4 adjusts focus by displacing the position of the lens 103 via an AF drive circuit 3.

A focal plane shutter 101 can freely control an exposure time of an image sensor 22 under the control of the system controller 50. The image sensor 22 is configured by a CCD element, a CMOS element, or the like that converts an optical image into an electrical signal. The image sensor 22 may include an image-plane phase difference sensor that outputs defocus amount information to the system controller 50. An A/D converter 23 (described as "A/D" in FIG. 2) converts an analog signal output from the image sensor 22 into a digital signal.

An image processor 24 applies predetermined processes (resizing processes, such as pixel interpolation and reduction, a color conversion process) to data from the A/D converter 23 or data from a memory controller 15. The image processor 24 performs a predetermined calculation process using captured image data. The system controller 50 performs exposure control and distance measurement control based on the calculation result obtained by the image processor 24. This allows an AF (autofocus) process, an AE (automatic exposure) process, an EF (flash pre- emission) process, etc. of a TTL (through-the-lens) method. The image processor 24 further performs a predetermined calculation process using the captured image data, and performs an AWB (auto white balance) process of the TTL method based on the obtained calculation result.

Output data from the A/D converter 23 is written to a memory 32 via the image processor 24 and the memory controller 15. Alternatively, the output data from the A/D converter 23 is written to the memory 32 via the memory controller 15 without passing through the image processor 24. The memory 32 stores image data obtained by the image sensor 22 and converted into digital data by the A/D converter 23, and image data to be displayed on the back-face display unit 28 and the EVF 29. The memory 32 has a storage capacity sufficient to store a predetermined number of still images, a predetermined time of moving images, and sound.

The memory 32 also serves as a video memory for displaying an image. A D/A converter 19 (described as "D/A" in FIG. 2) converts the data for image display stored in the memory 32 into analog signal and supplies the analog signal to the back-face display unit 28 or the EVF 29. In this way, the display image data written in the memory 32 is displayed on the back-face display unit 28 or the EVF 29 via the D/A converter 19.

Each of the back-face display unit 28 and the EVF 29 is an LCD or an organic EL, and displays an image according to an analog signal from the D/A converter 19. Digital signals A/D converted by the A/D converter 23 and accumulated in the memory 32 are converted into analog signals by the D/A converter 19, and are sequentially transferred to the back-face display unit 28 or the EVF 29 to be displayed, which enables live view display (LV). Hereinafter, an image displayed in the live view display is referred to as a live view image (LV image).

The system controller 50 includes at least one processor and/or at least one circuit, and controls the entire digital camera 100. The system controller 50 is a processor and is also a circuit. The system controller 50 executes a program recorded in a nonvolatile memory 56 to achieve each process of this embodiment described later. The system controller 50 controls the memory 32, the D/A converter 19, the back-face display unit 28, the EVF 29, and the like to perform display control.

The system memory 52 is, for example, a RAM, and the system controller 50 develops constants and variables for the operation of the system controller 50, and a program read from the nonvolatile memory 56 onto the system memory 52.

The nonvolatile memory 56 is an electrically erasable and programable memory like an EEPROM. The nonvolatile memory 56 stores constants, programs, etc. for the operation of the system controller 50. The programs mentioned here are used for executing processes of various flowcharts described later in this embodiment.

A system timer 53 is a time measurement unit that measures time used for various types of control and time of a built-in clock.

A communication unit 54 transmits and receives a video signal and an audio signal to and from an external apparatus connected wirelessly or via a wired cable. The communication unit 54 can also be connected to a wireless local area network (LAN) or the Internet. The communication unit 54 can also communicate with an external apparatus using Bluetooth (registered trademark) or Bluetooth Low Energy.

The communication unit 54 can transmit an image (including an LV image) captured by the image sensor 22 and an image recorded in the recording medium 200, and can receive various kinds of information such as image data and a moving image recording start instruction from an external apparatus. When the communication unit 54 receives the moving image recording start instruction from the external apparatus, the system controller 50 can notify the user of the reception of the instruction by lighting a light emitting unit 102 (see FIG. 1A) or by sounding an electronic sound using a loud speaker 92 (see FIG. 1A). Examples of an external apparatus that is a communication partner of the communication unit 54 include a smartphone, a tablet PC, and a desktop PC.

The posture detector 55 detects a posture of the digital camera 100 with respect to the gravity direction. Based on the posture detected by the posture detector 55, it is possible to determine whether an image is captured by the image sensor 22 while holding the digital camera 100 horizontally or vertically.

The system controller 50 can record an image captured by the image sensor 22 while adding orientation information corresponding to the posture detected by the posture detector 55 to an image file of the image or rotating the image. An acceleration sensor, a gyro sensor, or the like can be used as the orientation detector 55. Motions of the digital camera 100 (panning, tilting, lifting, stillness, etc.) can also be detected using the acceleration sensor or the gyro sensor as the posture detector 55.

An eye proximity detector 57 is an eye proximity sensor to detect proximity (eye proximity) and separation (eye separation) of an eye (object) to and from a finder eyepiece window 16 of an eyepiece finder 17 (hereinafter, simply referred to as a "finder") (proximity detection). The system controller 50 switches between display (display state)/non-display (non-display state) of the back-face display unit 28 and the EVF 29 in accordance with the state detected by the eye proximity detector 57.

More specifically, when the display destination switching setting is automatic switching and the eye is separated at least in the capturing standby state, the display destination is set to the back-face display unit 28 and the display of the back-face display unit 28 is turned on and the display of the EVF 29 is turned off. In addition, when the eye is in proximity, the display destination is set to the EVF 29, the display of the EVF 29 is turned on, and the display of the back-face display unit 28 is turned off.

The eye proximity detector 57 may be an infrared proximity sensor that can detect proximity of some object to the eyepiece window 16 of the eyepiece finder 17 including the EVF 29. When an object approaches, infrared light projected from a light emitter (not shown) of the eye proximity detector 57 is reflected by the object and received by a light receiver (not shown) of the infrared proximity sensor. The distance to the approaching object from the eyepiece window 16 can also be determined on the basis of an amount of infrared light received.

In this way, the eye proximity detector 57 detects the eye proximity by detecting the proximity distance of the object to the eyepiece window 16. When the object approaching the eyepiece window 16 within a predetermined distance from the eye separation state is detected, the eye proximity state to the eyepiece window 16 is determined. When the object that has been in the eye proximity state is separated from the eyepiece window 16 by the predetermined distance or more, the eye separation state is detected.

A threshold for detecting the eye proximity and a threshold for detecting the eye separation may be different from each other by, for example, providing hysteresis. After the eye proximity is detected, the eye proximity state is kept until the eye separation is detected. After the eye separation is detected, the eye separation state is kept until the eye contact is detected. The infrared proximity sensor is an example, and another sensor may be employed as the eye proximity detector 57 as long as the sensor can detect a state that can be regarded as eye proximity.

A GPS receiver 119 receives GPS signals for calculating location information and time information from GPS satellites. The digital camera 100 receives the GPS signals with the GPS receiver 119, and calculates the location information and the time information based on the received GPS signals. The digital camera 100 can add the calculated location information and time information to the captured image.

A hash value generator 210 generates (calculates) a hash value by executing a hash function on a still image file or a moving image file. The system controller 50 may generate the hash value instead of the hash value generator 210. A process to generate the hash value will be described in detail later.

An upper-face display drive circuit 44 displays various set values of the camera including the shutter speed and the aperture value on the upper-face display unit 43.

A power source controller 80 is configured by a battery detection circuit, a DC-DC converter, and a switch circuit to switch a block to be energized, and detects whether a battery is mounted, a type of the battery, and a remaining battery level. The power source controller 80 controls the DC-DC converter on the basis of the detection result and an instruction from the system controller 50, and supplies a necessary voltage from a power source 30 to units including the storage medium 200 for a necessary period. The power source 30 is constituted of a primary battery, such as an alkaline battery or a lithium battery, a secondary battery, such as a NiCd battery, a NiMH battery, or a Li battery, or an AC adapter.

A recording medium IF 18 (described as "IF" in FIG. 2) is an interface with the recording medium 200. The storage medium 200 is a memory card or a hard disk for recording a captured image, and is constituted by a semiconductor memory or a magnetic disk.

The operation unit 70 is an input unit that accepts an operation by a user (a user operation) and is used to input various operation instructions to the system controller 50. As illustrated in FIG. 2, the operation unit 70 includes the shutter button 61, the mode changeover switch 60, the power switch 72, the touch panel 70a, and other operation members 70b. The other operation members 70b include the main electronic dial 71, the sub electronic dial 73, the four-direction key 74, the set button 75, the moving image button 76, the AE lock button 77, the enlargement button 78, the playback button 79, the menu button 81, the touch bar 82, etc.

The shutter button 61 links with a first shutter switch 62 and a second shutter switch 64. The first shutter switch 62 is turned on in middle of a press operation of the shutter button 61, that is, by what is called a half-press (an instruction for preparing for image capturing), and generates a first shutter switch signal SW1. The system controller 50 starts a capturing preparatory operation, such as an AF process, AE process, AWB process, and EF process, in response to the first shutter switch signal SW1.

The second shutter switch 64 is turned on by completion of the press operation of the shutter button 61, that is, by what is called a full press (a capturing instruction), and generates a second shutter switch signal SW2. The system controller 50 starts a series of operations of the image capturing process from reading signals from the image sensor 22 to writing a captured image as an image file in the recording medium 200 in response to the second shutter switch signal SW2.

The mode changeover switch 60 switches the operation mode of the system controller 50 to any one of a still image capturing mode, a moving image capturing mode, a playback mode, and the like. The still image capturing mode includes an auto capturing mode, an auto scene determination mode, a manual mode, an aperture priority mode (Av mode), a shutter speed priority mode (Tv mode), and a program AE mode (P mode).

Further, there are various scene modes, which are capturing settings for respective capturing scenes, custom modes, etc. The user directly switches to any of these modes by operating the mode changeover switch 60. Alternatively, a screen showing the list of the capturing modes may be displayed in response to the operation of the mode changeover switch 60. The user switches to any one of the displayed modes by using another operation member. Similarly, the moving image capturing mode may include a plurality of modes.

The touch panel 70a is a touch sensor that detects various touch operations to a display surface of the back-face display unit 28 (an operation surface of the touch panel 70a). The touch panel 70a and the back-face display unit 28 can be integrally configured. For example, a right transmission rate of the touch panel 70a is designed so as not to disturb the display of the back-face display unit 28, and the touch panel 70a is attached as an upper layer of the display surface of the back-face display unit 28. Then, an input coordinates on the touch panel 70a is associated with a display coordinates on the display surface back-face display unit 28. This can provide a GUI (Graphical User Interface) on which a user operates as if the user directly operates a screen displayed on the back-face display unit 28.

The system controller 50 can detect the following operations or states on the touch panel 70a.

(1) A finger or a pen that has not touched the touch panel 70a newly touches the touch panel 70a. That is, the start of a touch (hereinafter referred to as "touch- down").

(2) A finger or a pen keeps touching the touch panel 70a (hereinafter referred to as "touch-on").

(3) A finger or a pen is moving while touching the touch panel 70a (hereinafter referred to as "touch-move").

(4) A finger or a pen that has been touching the touch panel 70a is released from the touch panel 70a. That is, the end of the touch (hereinafter referred to as "touch- up").

(5) Nothing touches the touch panel 109 (hereinafter referred to as "touch-off').

When the touch-down is detected, the touch-on is also detected at the same time. After the touch-down, the touch-on is normally continuously detected unless the touch-up is detected. When the touch-move is detected, the touch-on is also detected at the same time. Even if the touch-on is detected, the touch-move is not detected unless the touch position is not moving. After the touch-up of all the fingers or the pen that have been touching is detected, the touch-off is detected.

The system controller 50 is notified of these operations and states and the position coordinate touched by the finger or the pen on the touch panel 70a through the internal bus. Then, the system controller 50 determines what operation (touch operation) has been performed on the touch panel 70a based on the notified information. As for the touch-move, a moving direction of a finger or a pen moving on the touch panel 70a can be determined for each of vertical and horizontal components on the touch panel 70a based on a change in the position coordinate.

When the touch-move of a predetermined distance or more is detected, it is determined that a slide operation has been performed. An operation of quickly moving a finger on the touch panel 109 by a certain distance while keeping the finger in contact with the touch panel and then releasing the finger is called a flick. In other words, the flick is an operation of quickly tracing the touch panel 70a with a finger as if flicking the touch panel. When the touch-move of the predetermined distance or more at a predetermined speed or more is detected and the touch-up is detected after that, it can be determined that the flick has been performed (it can be determined that a flick has been performed following a slide operation).

Further, a touch operation of touching a plurality of points (for example, two points) together (multi-touch) and bringing the touch positions closer to each other is referred to as a pinch-in, and a touch operation of moving the touch positions away from each other is referred to as a pinch-out. The pinch-out and the pinch-in are collectively referred to as a pinch operation. The touch panel 70a may be any type of touch panel among various types of touch panels, such as a resistive film type, a capacitive type, a surface-acoustic-wave type, an infrared type, an electromagnetic-induction type, an image recognition type, and an optical sensor type. There are a method of detecting a touch by a contact with the touch panel and a method of detecting a touch by proximity of a finger or a pen to the touch panel, and any method may be used.

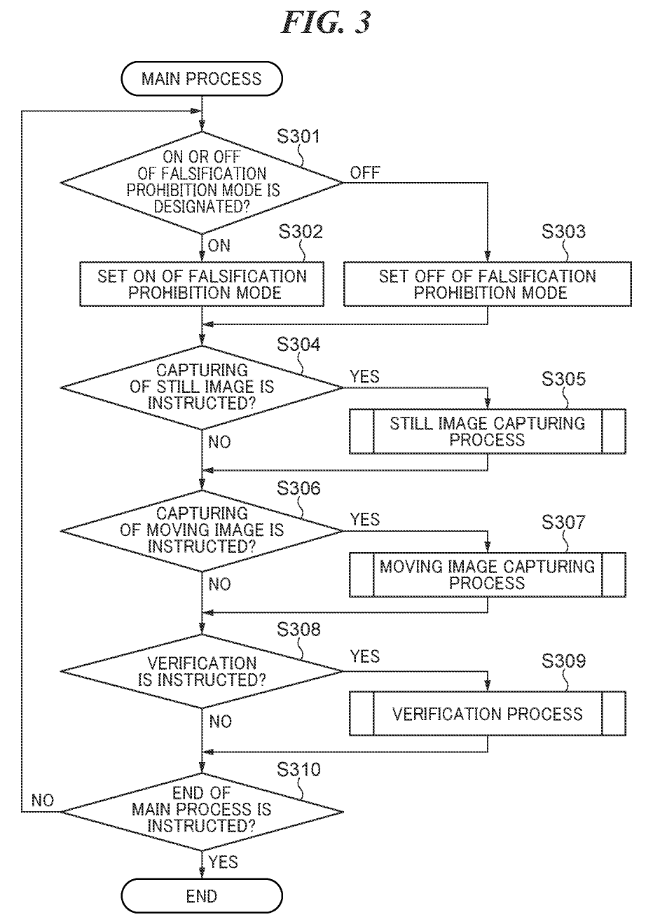

FIG. 3 is a flowchart illustrating procedures of a main process executed by the digital camera 100 in FIG. 1A. The main process in FIG. 3 is achieved by the system controller 50 developing a program stored in the nonvolatile memory 56 onto the system memory 52 and executing the program. The main process in FIG. 3 is started, for example, when the user presses the power switch 72 to activate the digital camera 100 and further operates the touch panel 70a to give a menu switching instruction.

When receiving the menu switching instruction, the digital camera 100 displays a setting screen to set a falsification prohibition mode on the back-face display unit 28. On this setting screen, the user can select either "ON" to enable the falsification prohibition mode or "OFF" to disable the falsification prohibition mode. In the present embodiment, when an image is captured in a state where the falsification prohibition mode is set to "ON", a still image file or a moving image file obtained by the capturing includes history information described later. On the other hand, when an image is captured in a state where the alteration prohibition mode is set to "OFF", a still image file or a moving image file obtained by the capturing does not include the history information.

As shown in FIG. 3 , the system controller 50 first determines whether the user designates "ON" or "OFF" of the falsification prohibition mode on the setting screen in S301. When it is determined that the user designates "ON" on the setting screen, the process proceeds to S302. When it is determined that the user designates "OFF" on the setting screen, the process proceeds to S303.

In S302, the system controller 50 sets the falsification prohibition mode to "ON". As a result, the falsification prohibition mode is enabled in the digital camera 100. A set value indicating that the falsification prohibition mode is enabled is stored in the memory 32. Then, the process proceeds to S304 described later.

In S303, the system controller 50 sets the falsification prohibit mode to "OFF". This disables the falsification prohibition mode in the digital camera 100. A set value indicating that the falsification prohibition mode is disabled is stored in the memory 32.

Next, in S304, the system controller 50 determines whether capturing of a still-image is instructed. In the present embodiment, the user can instruct to capture a still image by pressing, for example, the shutter button 61. When it is determined that the capturing of a still image is instructed, the process proceeds to S305. When it is determined that the capturing of a still image is instructed, the process proceeds to S306.

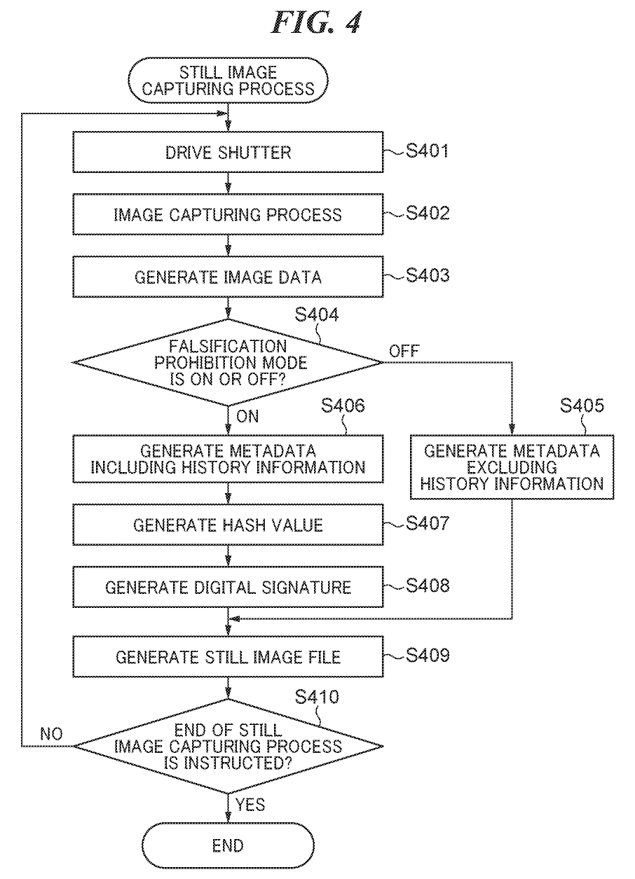

In S305, the system controller 50 performs a still image capturing process in FIG. 4 described later, and generates a still image file including image data obtained by capturing a still image. The configuration of the still image file will be described later.

Next, in S306, the system controller 50 determines whether capturing of a moving image is instructed. In the present embodiment, the user can instruct to capture a moving image by pressing the moving image button 76, for example. When it is determined that the capturing of a moving image is instructed, the process proceeds to S307. When it is determined that the capturing of a moving image is not instructed, the process proceeds to S308.

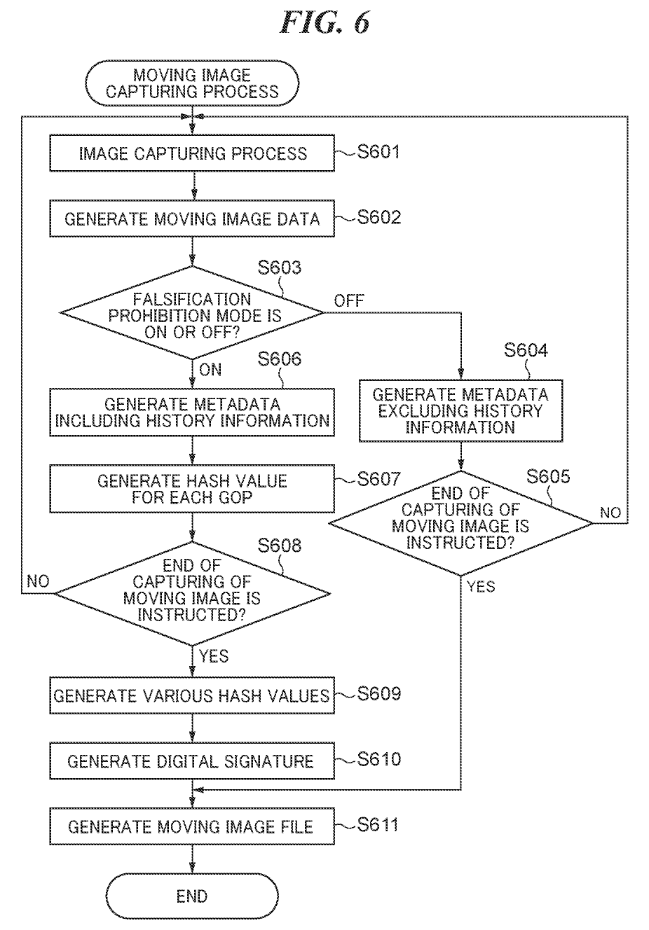

In S307, the system controller 50 performs a moving image capturing process in FIG. 6 described later, and generates a moving image file including moving image data obtained by capturing a moving image. The configuration of the moving image file will be described later.

Next, in S308, the system controller 50 determines whether verification is instructed. In the present embodiment, the user can instruct verification by operating the touch panel 70a, for example. When it is determined that the verification is instructed, the process proceeds to S309. When it is determined that the verification is not instructed, the process proceeds to S310.

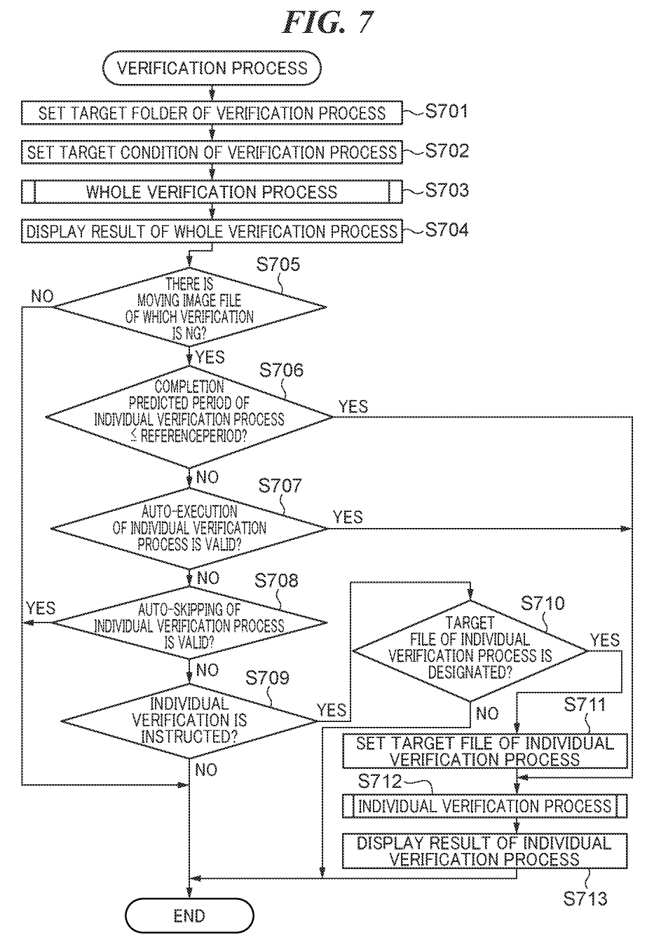

In S309, the system controller 50 performs a verification process in FIG. 7 described below, to detect falsification of the still image file or the moving image file stored in the recording medium 200.

Next, in S310, the system controller 50 determines whether end of the main process is instructed. In the present embodiment, the user can instruct the end of the main process by pressing the power switch 72, for example. When it is determined that the end of the main process is not instructed, the process returns to S30 1. When it is determined that the end of the main process is instructed, the present process ends.

FIG. 4 is a flowchart illustrating procedures of the still image capturing process in S305 in FIG. 3. This process starts when an operation such as a press of the shutter button 61 is received, and ends when an operation such as stop of the press of the shutter button 61 is received.

As shown in FIG. 4, the system controller 50 drives the shutter 101, which is located on the object side of the image sensor 22, to control an exposure time in S401.

Next, in S402, the system controller 50 performs an image capturing process to convert light from an object received by the image sensor 22 through the shutter 101 into an electric signal (analog image data).

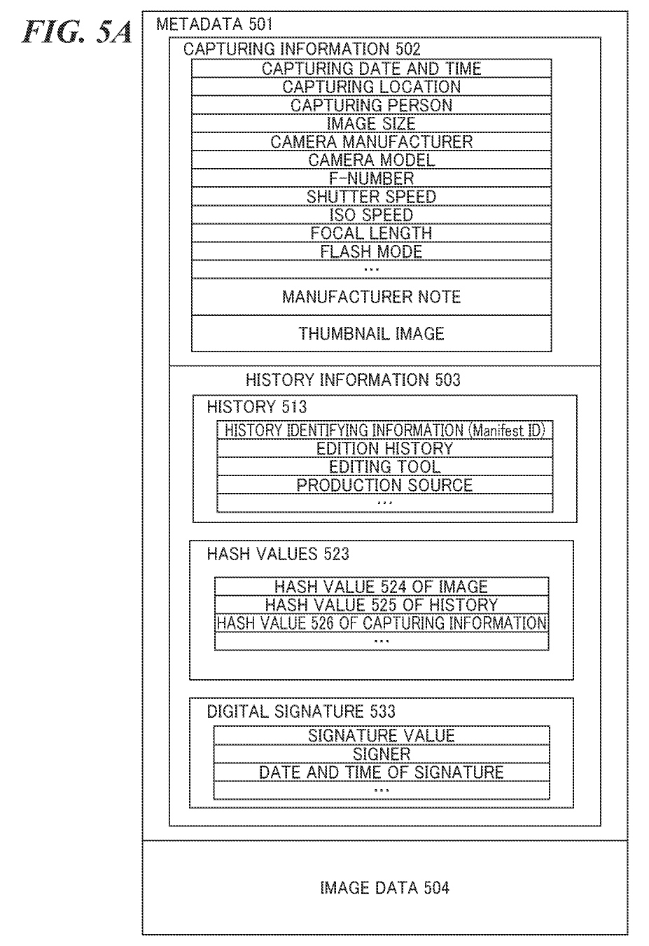

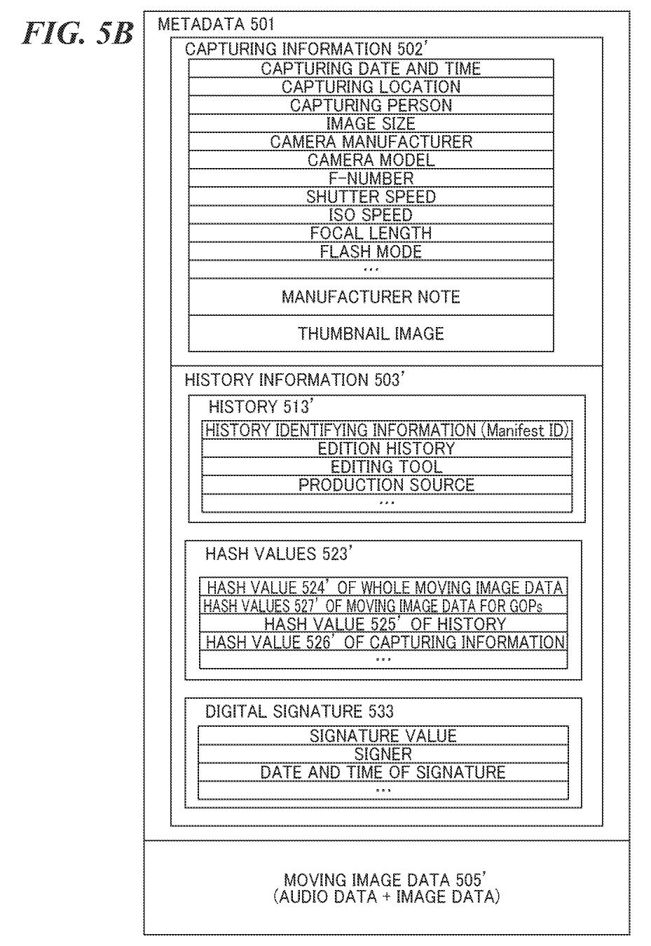

Next, in S403, the system controller 50 applies image processes, such as a developing process and an encoding process, to the electrical signal obtained by the image capturing process, and generates image data 504 in FIG. 5A.

Next, in S404, the system controller 50 determines whether the set value of the falsification prohibition mode is "ON" or "OFF". When it is determined that the set value of the falsification prohibition mode is "OFF", the process proceeds to S405. When it is determined that the set value of the falsification prohibition mode is "ON", the process proceeds to S406.

In S405, the system controller 50 generates metadata excluding history information. The metadata includes capturing information 502 in FIG. 5A. The capturing information 502 is information at the time of execution of the image capturing process for generating the image data 504, and includes, for example, capturing date and time, a capturing location, a capturing person, an image size, a manufacturer or a model of the digital camera 100, various capturing parameters set at the time of capturing, a thumbnail image, etc. The capturing information 502 is generated in accordance with a predetermined technical standard, for example, the EXIF (Exchangeable Image File) format. Then, the process proceeds to S409 described later.

In S406, the system controller 50 generates metadata 501 in FIG. 5A. The metadata 501 includes the above-described capturing information 502 and the history information 503. The history information 503 is information to certificate believability of the image data 504 generated in S403, and is used when verifying a source and history of the image data 504.

The history information 503 is generated in accordance with a predetermined technical standard, for example, C2PA (Coalition for Content Provenance and Authenticity), and has a prescribed structure. The history information 503 includes, for example, a history 513 (assertion), hash values 523 to guarantee the history 513, and a digital signature 533. The history 513 includes history identification information (Manifest ID) to uniquely identify the history 513, an editing history indicating an editing content of the image data 504 generated in 5403, an editing tool indicating a tool used for the editing, and information indicating a creator of the image data 504. Since the image data 504 generated in S403 is just generated by capturing and is not edited, information indicating "generated" is recorded in the editing history, and information indicating the digital camera 100 is recorded in the editing tool.

Then, in S407, the system controller 50 generates hash values 523 to be included in the history information 503. For example, the system controller 50 performs a hash function on binary data of the image data 504 and binary data of the history 513 to generate a hash value 524 of the image data and a hash value 525 of the history. Note that a hash value 526 of the image capturing information may be generated by performing the hash function on binary data of the image capturing information 502.

Then, in S408, the system controller 50 generates a digital signature 533 to be included in the history information 503. The digital signature 533 includes information indicating a signature value, a signer, and signature date and time. The signature value is generated by encrypting the hash values 523 generated in S407 using a secret key prepared in advance. A public key paired with the secret key used here is also included in the digital signature 533. At this time, the digital signature 533 may include information indicating the manufacturer of the digital camera 100 as a signer in order to certify that the public key is generated by a reliable manufacturer or a public key certificate indicating that the public key is certified by a certification authority. By attaching the digital signature 533 including such a signer to the still image file, it is possible to show that the still image file is reliable. The model name of the digital camera 100 may be used as the signer instead of the manufacturer. The signature date and time on which the digital signature 533 has been generated are recorded.

Next, in S409, the system controller 50 generates a still image file. For example, when the set value of the falsification prohibition mode is "ON", a still image file in FIG. 5A is generated. The still image file includes the metadata 501 generated in S406 including the capturing information 502 and the history information 503, and the image data 504 generated in S403. The image data 504 is generated in accordance with a still image format such as a JPEG format.

On the other hand, when the set value of the falsification prohibition mode is "OFF", a still image file including the metadata generated in S405 and the image data 504 generated in S403 is generated. The metadata generated in S405 includes the capturing information 502 and does not include the history information 503.

Next, in S410, the system controller 50 determines whether end of the still image capturing process is instructed from the user. When it is determined that the end of the still image capturing process is not instructed, the process returns to S401. When it is determined that the end of the still image capturing process is instructed, the present process ends.

As described above, in the present embodiment, when the digital camera 100 performs the still image capturing, the still image file is generated. The still image file may be edited by an application. When the still image file is edited in a proper procedure using an authorized editing tool, new history information is generated in accordance with a predetermined technical standard based on an editing content, and the new history information is added to the metadata 501 of the still image file. In this manner, new history information is added to the metadata 501 of the still image file every time the still image file is edited.

On the other hand, when the still image file is edited using an unauthorized editing tool or in an improper procedure, no history information may be added to the metadata 501 of the still image file, or the history information added to the metadata 501 of the still image file may not conform to the predetermined technical standard.

Further, the generation of the hash values 523 and the digital signature 533 enables detection of falsification of the still image file. For example, the hash function is performed on the binary data of the image data 504 of the still image file to generate a hash value. Then, the generated hash value is compared with the hash value 524 of the image data included in the still image file of a determination target. This enables to verify presence or absence of falsification in the image data 504.

Similarly, the hash function is executed on the binary data of the image capturing information 502 of the still image file to generate a hash value. The generated hash value is compared with the hash value 526 of the capturing information included in the still image file of the determination target. This enables to verify presence or absence of falsification in the capturing information 502. As shown in this embodiment, only the selected data can be set as a history assurance target, and this technique is applicable to not only the image capturing apparatus but also an editing application or the like.

Further, the hash function is executed on the binary data of the history 513 to generate a hash value. Then, the generated hash value is compared with the hash value 525 of the history included in the still image file of the determination target. This enables to verify presence or absence of falsification in the history 513.

At this time, the binary data may be compared in finer units, such as the edition history, the creator, the thumbnail data, and the metadata. The signature value can be decrypted by the public key, and if the hash values match, it can be determined that the verification of the signature value has succeeded. In this way, the mechanism to detect falsification can be incorporated into the still image file.

FIG. 6 is a flowchart illustrating procedures of the moving image capturing process in S307 in FIG. 3. This process starts when an operation such as press of the moving image button 76 is accepted and ends when an operation such as press of the moving image button 76 is accepted during the moving image capturing.

As shown in FIG. 6 , the system controller 50 performs the image capturing process to convert the light from an object received by the image sensor 22 into an electric signal (analog image data) in S601.

Next, in S602, the system controller 50 performs the image processes, such as the development process and the coding process, on the electric signal obtained by the image capturing process to generate moving image data 505' shown in FIG. 5B.

At this time, the system controller 50 groups frames constituting the moving image data 505' into a plurality of frame groups (Group Of Pictures (hereinafter referred to as "GOP")).

Next, in S603, the system controller 50 determines whether the set value of the falsification prohibition mode is "ON" or "OFF". When it is determined that set value of the falsification prohibition mode is "OFF", the process proceeds to S604.

In S604, the system controller 50 generates a metadata excluding history information. The metadata includes capturing information 502' in FIG. 5B. The capturing information 502' is information when the image capturing process to generate the moving image data 505' is executed, and includes, for example, capturing date and time, a capturing person, an image size, a manufacturer or a model of the digital camera 100, various capturing parameters set at the time of capturing, a capturing place, and a thumbnail image. The capturing information 502' is generated in accordance with a predetermined technical standard, for example, the EXIF (Exchangeable Image File) format.

Next, in S605, the system controller 50 determines whether end of the moving image capturing is instructed from the user. When it is determined that the end of the moving image capturing is not instructed, the process returns to S601. When it is determined that the end of the moving image capturing is instructed, the process proceeds to S611 described later.

When it is determined in 5603 that the set value of the falsification prohibition mode is "ON", the process proceeds to S606. In 5606, the system controller 50 generates metadata 501' in FIG. SB. The metadata 501' includes the capturing information 502' and history information 503'.

The history information 503' is information to certificate believability of the moving image data 505', and is used when verifying a source or history of the moving image data 505'. The history information 503' is generated in accordance with a predetermined technical standard, for example, C2PA (Coalition for Content Provenance and Authenticity), and has a prescribed structure.

The history information 503', includes a history 513', (Assertion), hash values 523' to guarantee the history 513', and digital signature 533'. The history 513',includes history identification information (also referred to as Manifest ID) to uniquely identify the history 513', and editing history indicating an editing content of the moving image data 505', and editing tool indicating a tool used for the editing, and information about a creator of the moving image data 505'. Here, since the moving image data 505', generated in S602 is just generated by capturing and is not edited, information indicating "generated" is recorded in the editing history and information indicating the digital camera 100 is recorded in the editing tool.

Next, in S607, the system controller 50 generates hash values 527' (second- type hash values) of the moving image data for the respective GOPs. Specifically, the system controller 50 executes the hash function on binary data of the respective GOPs of the moving image data 505' to generate the hash values 527' of the moving image data for the respective GOPs.

These hash values are used as individual hash values for specifying a falsified portion in more detail than a whole hash value 524' of the whole moving image data described later. As long as this purpose is maintained, the individual hash values may be generated by performing the hash function on binary data of GOP groups each of which includes a plurality of GOPs of the moving image data 505' instead of performing the hash function on binary data of the respective GOPs.

Next, in S608, the system controller 50 determines whether end of the moving image capturing is instructed from the user. When it is determined that the end of the moving image capturing is not instructed, the process returns to 5601. When it is determined that the end of the moving image capturing is instructed, the process proceeds to S609.

In S609, the system controller 50 generates various hash values to be included in the history information 503'. Specifically, the system controller 50 executes the hash function on binary data of the moving image data 505' and binary data of the history 513' to generate the whole hash value 524' of the whole moving image data (a first-type hash value) and a hash value 525' of the history. The system controller 50 may generate a hash value 526' of the capturing information by executing the hash function on binary data of the capturing information 502'. The whole hash value of the whole moving image data generated in S609 is used to detect the falsification in the verification process in FIG. 7 described later.

Then, in S610, the system controller 50 generates the digital signature 533' in FIG. 5B The digital signature 533' includes information indicating a signature value, a signer, and signature date and time. The signature value is generated by encrypting the generated hash value 533' using a secret key prepared in advance. A public key paired with the secret key used here is also included in the digital signature 533'.

At this time, the digital signature 533' may include information indicating the manufacturer of the digital camera 100 as a signer in order to certify that the public key is generated by a reliable manufacturer or a public key certificate indicating that the public key is certified by a certification authority. By attaching the digital signature 533' including such a signer to the moving image file, it is possible to show that the moving image file is reliable. The model name of the digital camera 100 may be used as the signer instead of the manufacturer. The signature date and time when the digital signature 533' has been generated are recorded.

Then, in S611, the system controller 50 generates a moving image file. For example, when the set value of the falsification prohibition mode is "ON", the moving image file shown in FIG. 5B is generated. The moving image file includes the metadata 501' including capturing information 502', the history information 503', and the moving image data 505' generated in S602. The moving image data 505' is generated in accordance with a moving image format such as an MPEG format.

On the other hand, when the set value of the falsification prohibition mode is "OFF", a moving image file constituted by the metadata generated in S604 and the moving image data 505' generated in S602 is generated. The metadata generated in S604 includes the capturing information 502' and does not include the history information 503'. When the process in S611 is completed, the process ends.

As described above, in the present embodiment, when the digital camera 100 captures the moving image, the moving image file is generated. The moving image file may be edited by an application or the like. When the moving image file is edited in a proper procedure using an authorized editing tool, new history information is generated in accordance with a predetermined technical standard based on an editing content, and the new history information is added to the metadata 501' of the moving image file. In this manner, new history information is added to the metadata 501' of the moving image file every time the moving image file is edited.

On the other hand, when the moving image file is edited using an unauthorized editing tool or in an improper procedure, no history information may be added to the moving image file, or the history information added to the moving image file may not conform to the predetermined technical standard.

Further, the generation of the hash values 523' and the digital signature 533' enables detection of falsification of the moving image file. For example, the hash function is performed on the whole binary data of the moving image data 505' of the moving image file to generate a hash value. Then, the generated hash value is compared with the whole hash value 524' of the whole moving image data of the moving image file of a determination target. This enables to verify presence or absence of falsification in the moving image data 505'.

Similarly, the hash function is executed on the binary data of the capturing information 502' of the moving image file to generate a hash value. Then, the generated hash value is compared with the hash value 526' of the capturing information of the moving image file of the determination target. This enables to verify presence or absence of falsification in the capturing information 502'.

Further, the hash function is executed on binary data of the GOPs of the moving image data 505' in the moving image file, and a plurality of hash values corresponding to the respective GOPs are generated. Then, the plurality of generated hash values are respectively compared with the hash values 527' of the moving image data for the GOPs of the moving image file of the determination target. This enables to verify presence or absence of falsification of the moving image data in a unit of GOP.

A still image file and a moving image file obtained by capturing or editing by another device are also stored in the recording medium 200 of the digital camera 100 in addition to the still image file and the moving image file obtained by capturing by the digital camera 100. Since a still image file or a moving image file obtained from another device may be fraudulently falsified, it is necessary to verify presence or absence of falsification.

On the other hand, when falsification of a moving image file is verified by using the hash values 527' for the GOPs, it is possible to specify not only presence or absence of falsification in the moving image data but also a frame in which the moving image data is falsified. However, when the hash values 527' for the GOPs in the moving image data are used as described above, the number of the hash values increases by the number of GOPs, the time required for verification increases and the usability decreases.

Therefore, in the present embodiment, when falsification is detected in a whole verification process (a first process) using the hash value generated by executing the hash function on the whole moving image data, it is controlled whether to execute an individual verification process (a second process) using the plurality of hash values corresponding to the GOPs of the moving image data.

FIG. 7 is a flowchart illustrating procedures of the verification process in S309 in . This process is started by receiving a verification instruction in S308 described above. When the verification instruction is received, the system controller 50 causes the back-face display unit 28 to display a folder selection screen in . On the folder selection screen, the user can select a folder in which a file to be subjected to the verification process is stored from among a plurality of folders configured in the recording medium 200.

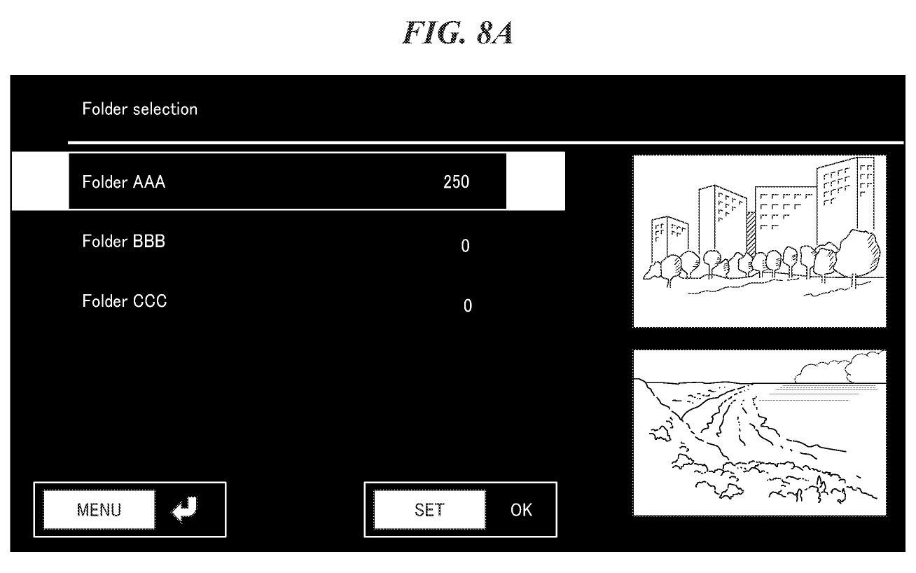

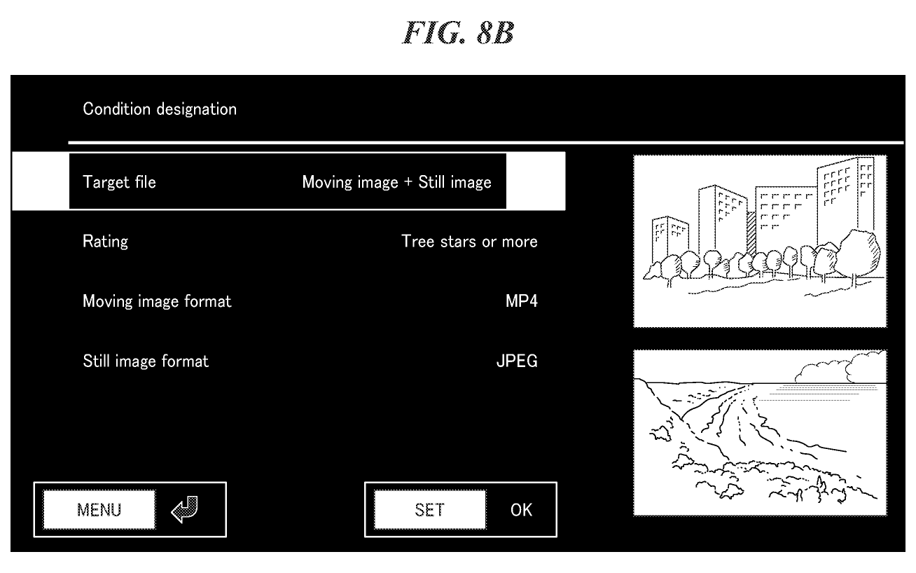

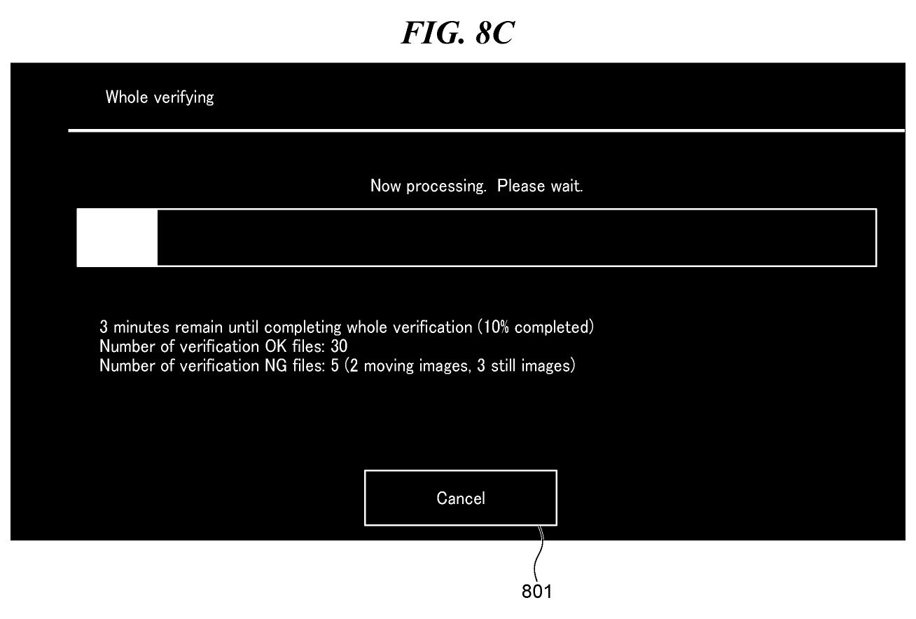

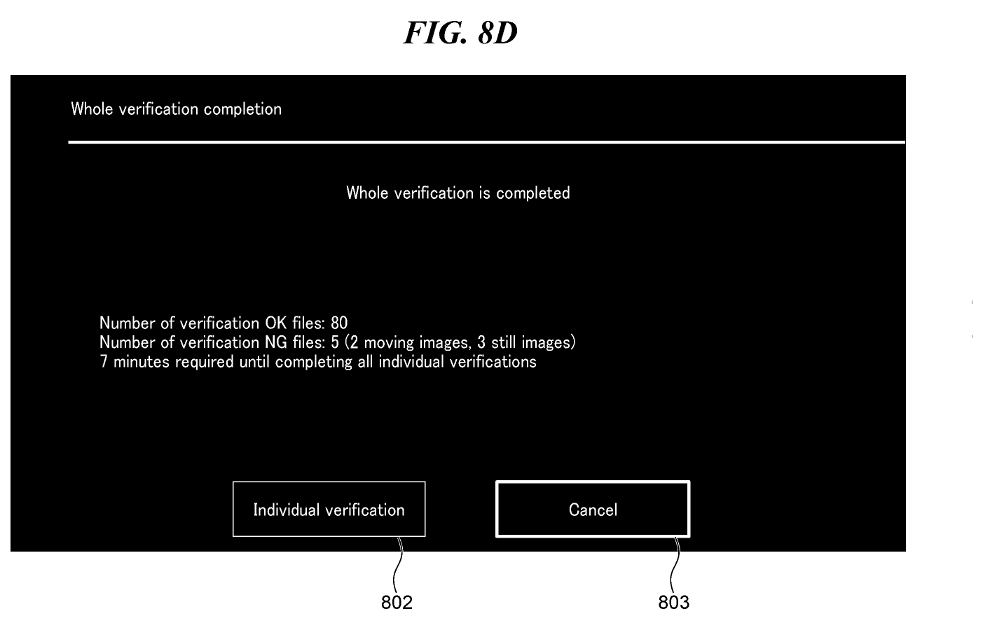

As shown in FIG. 7, the system controller 50 sets a folder designated by the user on the folder selection screen as a target folder of the verification process in S701. When the user selects a "SET" button in a state where the folder is selected on the folder selection screen, the screen of the back-face display unit 28 is switched to a condition designation screen in FIG. 8B.

Although a folder storing a file to be subjected to the verification process is designated in the present embodiment, the file to be subjected to the verification processing may be designated.

Next, in S702, the system controller 50 sets set values designated by user on the condition designation screen in FIG. 8B as target conditions of the verification process. On the condition designation screen, the target conditions of the verification process to narrow down target files of the verification process from among the plurality of files stored in the target folder set in S701, are set.

In the present embodiment, the user can designate, as the target conditions of the verification process, for example, a target file type such as a moving image or a still image, a rating indicating a favorite level set by the user, a moving image format such as MP4, and a still image format such as JPEG. When the user selects "SET" button in a state where the set values are set on the condition designation screen, the process proceeds to S703.

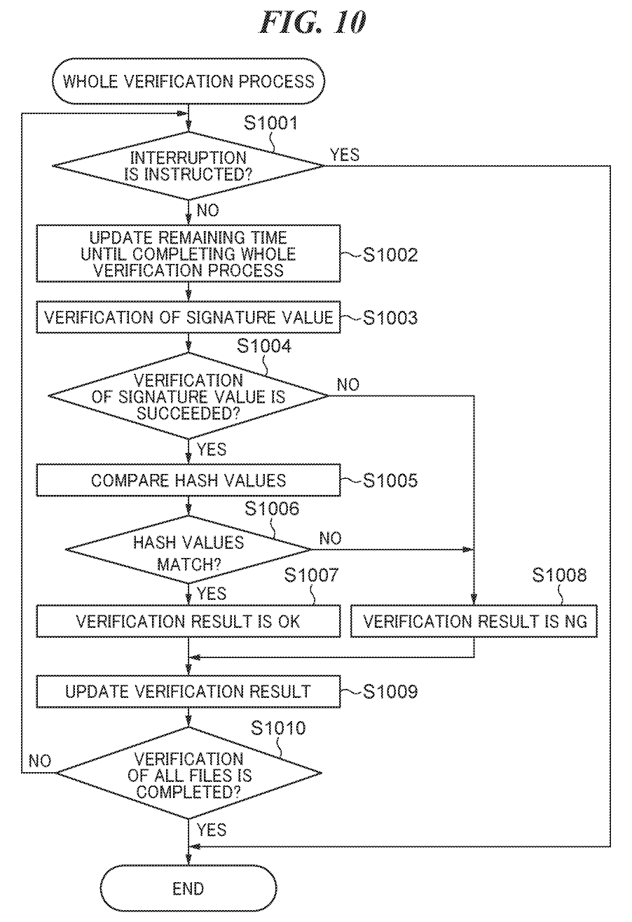

In S703, the system controller 50 performs the whole verification process in FIG. 10 described later using the whole hash value 524' of the whole moving image data. During the whole verification process, a whole verification ongoing screen in FIG. 8C indicating that the whole verification process is being executed is displayed on the back-face display unit 28. This screen includes a cancel button 801 to instruct interruption of the whole verification process.

Next, in S704, the system controller 50 displays a whole verification completion screen indicating a result of the whole verification process on the back- face display unit 28. is a view illustrating an example of the whole verification completion screen that indicates the number of verification OK files and the number of verification NG files. In addition, the number of verification NG files breaks down into the number of NG moving images and the number of NG still images. A verification NG file is a falsified file.

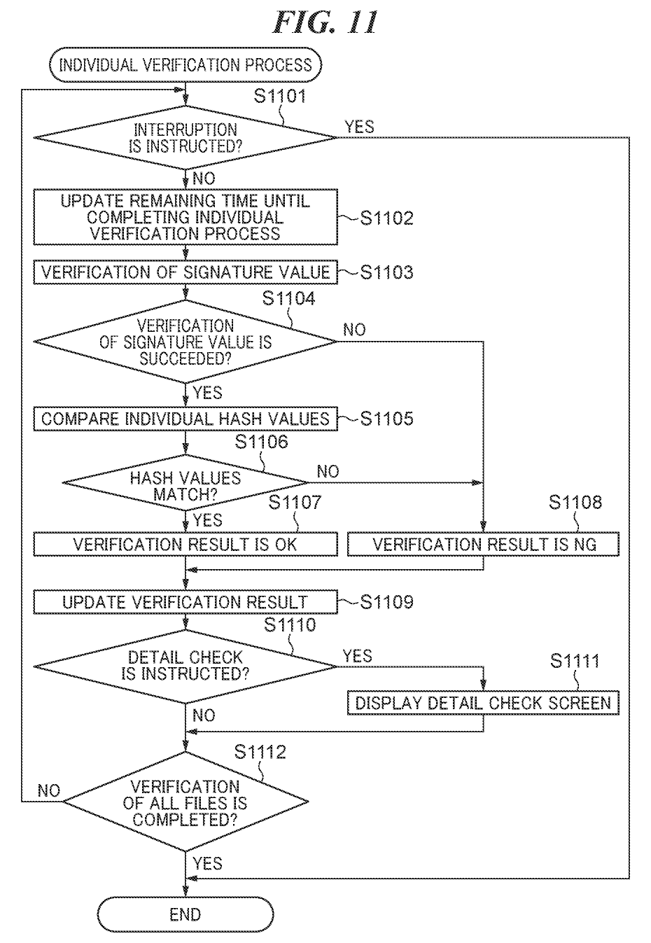

This screen further includes an individual verification button 802 to instruct execution of the individual verification process described later and a cancel button 803 to instruct cancellation of the individual verification process. In addition, the screen may further display (present) a completion prediction period of the individual verification process in FIG. 11 described later.

Next, in S705, the system controller 50 determines whether there is a moving image file of which the verification result is NG in the whole verification process. When it is determined that there is no moving image file of which the verification result is NG in the whole verification process, the process is terminated. When it is determined that there is a moving image file of which the verification result is NG in the whole verification process, the process proceeds to S706.

In S706, the system controller 50 determines whether a completion prediction period of the individual verification process for all the moving image files of which the verification result is NG is equal to or less than a predetermined reference period. When it is determined that the completion prediction period of the individual verification process for all the moving images file of which the verification result is NG is equal to or less than the reference period, the process proceeds to S712 described later. That is, in this case, the individual verification process is executed for all the moving image files of which the verification result is NG without selecting a target file of the individual verification process by the user.

On the other hand, when it is determined that the completion prediction period of the individual verification process for all the moving image files of which the verification result is NG is more than the reference period, the process proceeds to S707.

In S707, the system controller 50 determines whether auto-execution of the individual verification process, which is a function of always executing the individual verification process when falsification is detected in the whole verification process, is valid. When it is determined that the auto-execution of the individual verification process is valid, the process proceeds to S712 described later. That is, in the present embodiment, when the auto-execution of the individual verification process is valid, the individual verification process is executed for all the moving images files of which the verification result is NG.

On the other hand, when it is determined that the auto-execution of the individual verification process is invalid, the process proceeds to S708. Although the user shall set the auto-execution of the individual verification process in the present embodiment, another method may be used.

In S708, the system controller 50 determines whether auto-skipping of the individual verification process, which is a function of not executing the individual verification process even when falsification is detected in the whole verification process, is valid. When it is determined that the auto-skipping of the individual verification process is valid, the process ends without performing the individual verification process.

When it is determined that the auto-skipping of the individual verification process is invalid, the process proceeds to S709. Although the user shall set the auto-skipping of the individual verification process in the present embodiment, another method may be used.

In S709, the system controller 50 determines whether the individual verification is instructed. In the present embodiment, the user can instruct the individual verification by selecting the individual verification button 802 displayed on the whole verification completion screen in FIG. 8D. When it is determined that the individual verification is not instructed, that is, when the user presses the cancel button 803, the process ends. When it is determined that the individual verification is instructed, that is, when the user presses the individual verification button 802, the process proceeds to S710.

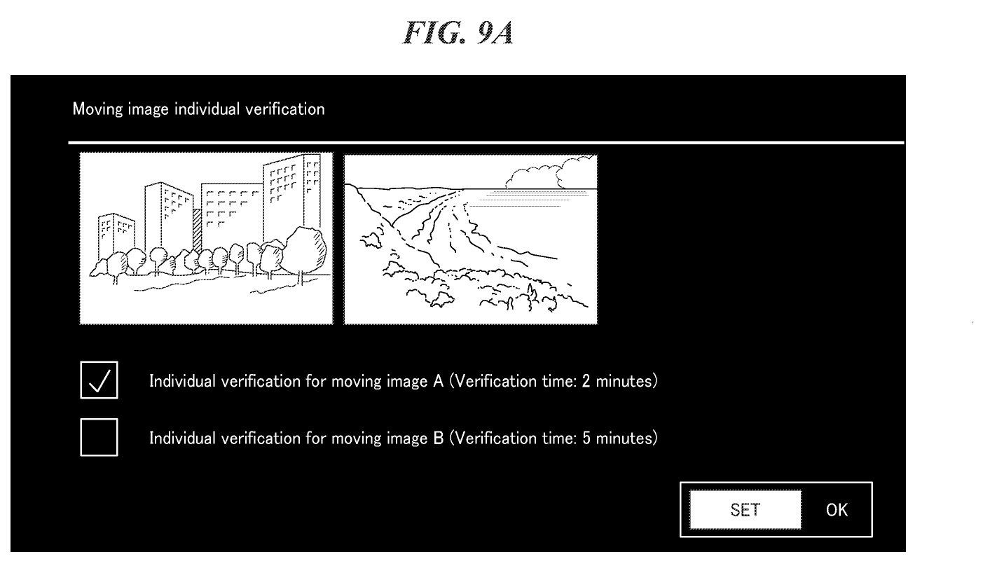

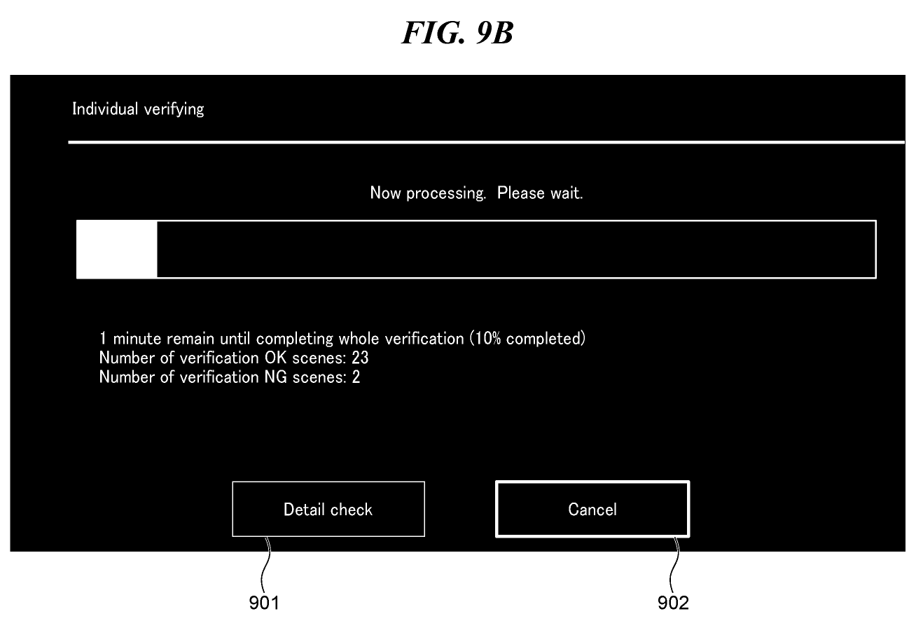

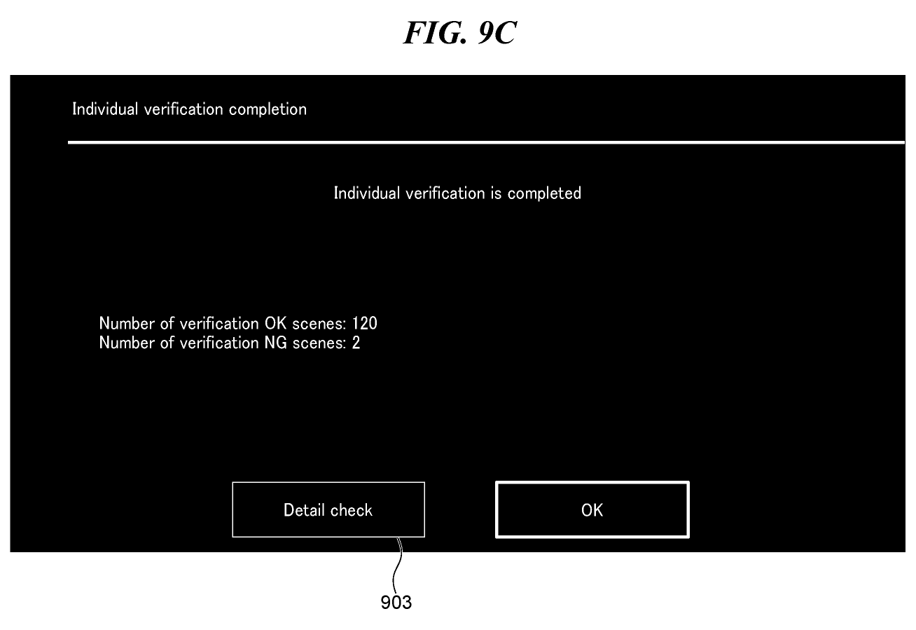

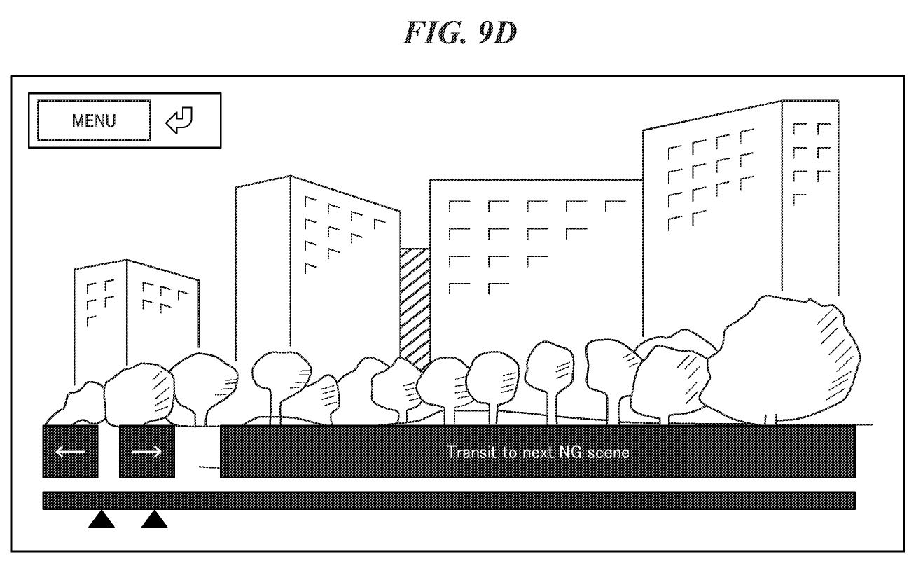

In S710, the system controller 50 determines whether the target file of the individual verification process is designated by the user. In the present embodiment, when the user presses the individual verification button 802, the screen on the back- face display unit 28 is switched to a moving-image individual verification screen in FIG. 9A. On this screen, a moving image file of which verification result is NG and a predicted period required for the individual verification process of the moving image file are displayed.

The user can designate a target file of the individual verification process on this screen. When it is determined that the target file of the individual verification process is not designated by the user, the process is terminated. When it is determined that the target file of the individual verification process is designated by the user, the process proceeds to S711.

In S711, the system controller 50 sets the file designated by the user on this screen as the target file of the individual verification process.

Next, in S712, the system controller 50 performs the individual verification process in FIG. 11 described later. During the individual verification process, an individual verification ongoing screen in FIG. 9B indicating that the individual verification process is being executed is displayed on back-face display unit 28. This screen includes a detail check button 901 to check a detailed scene of which the verification result is NG and a cancel button 902 to instruct interruption of the individual verification process.

Next, in S713, the system controller 50 displays a result of the individual verification process on the back-face display unit 28. FIG. 9C is a view illustrating an example of an individual verification completion screen on which the number of verification OK scenes and the number of verification NG scenes are displayed. In the present embodiment, the user can also check a detailed scene of which the verification result is NG as shown in FIG. 9D by pressing a detail check button 903 included in the screen. When the process in S611 is completed, the process ends.

FIG. 10 is a flowchart illustrating procedures of the whole verification process in S703 in FIG. 7 When the whole verification process is started, a whole verification ongoing screen in FIG. 8C including progress information about the whole verification process is displayed on the back-face display unit 28. As described above, this screen includes the cancel button 801 to instruct interruption of the whole verification process.

In FIG. 10, in S1001, the system controller 50 determines whether interruption of the whole verification process is instructed. When it is determined that the interruption of the whole verification process is instructed, that is, when the user presses the cancel button 801, the process ends. When it is determined that the interruption of the whole verification process is not instructed, the process proceeds to S1002.

In S1002, the system controller 50 updates remaining time until completing the whole verification process. Accordingly, the user can understand the remaining time of the whole verification process. In addition, in S1002, information about a progress rate indicating a percentage of completion of the whole verification may be displayed on the whole verification ongoing screen in FIG. 8C in addition to the remaining time.

Next, the system controller 50 selects one file from among a plurality of files that are stored in the folder set as the target folder of the verification process and satisfy the target conditions of the verification process set in S702.

Then, in S1003, the system controller 50 verifies the signature value of the selected file. For example, when the selected file is the moving image file having the configuration illustrated in FIG. 5B, the system controller 50 first decrypts the digital signature 533' of the history information 503' in the selected moving image file with the public key. When the digital signature 533' is generated using the secret key that is paired with the public key, the signature value can be correctly decrypted using the public key. The system controller 50 executes the hash function on the binary data of the history 513' to generate a hash value, and determines whether the generated hash value matches the hash value decrypted with the public key.

Then, in S1004, the system controller 50 determines whether the verification of the signature value is succeeded. In S1004, when the signature value is not correctly decrypted with the public keys or when the two hash values do not match, it is determined that the verification of the signature value is failed, and the process proceeds to S1008 described later. On the other hand, when the signature value is correctly decrypted with the public keys and the two hash values match, it is determined that the verification of the signature value is succeeded, and the process proceeds to S 1005.

In S1005, the system controller 50 compares the hash values of the selected file. For example, when the selected file is the moving image file having the configuration illustrated in FIG. 5B, the system controller 50 generates a hash value by executing the hash function on the binary data of the moving image data 505' in the moving image file. Then, the system controller 50 compares the generated hash value with the whole hash value 524' of the whole moving image data in the moving image file.

Next, in S1006, the system controller 50 determines whether these hash values match each other based on the result of the comparison in S1005. When it is determined that these hash values match, the process proceeds to S1007. When it is determined that these hash values do not match, the process proceeds to S1008.

In S1007, the system controller 50 determines that the verification result of the whole verification process of the selected file is OK. Thereafter, the process proceeds to S1009.

In S1008, the system controller 50 determines that the verification result of the whole verification process of the selected file is NG.

Then, in S1009, the system controller 50 updates the verification result. Based on the updated verification result, the information indicating the verification result (the number of verification OK files, the number of verification NG files, the numbers of moving image files and still image files in which falsification is detected) displayed on the whole verification ongoing screen in is updated.

Next, in S1010, the system controller 50 determines whether the verification of all the files subjected to the whole verification process is completed. The files subjected to the whole verification process are stored in the folder set as the target folder of the verification process and satisfy the target conditions of the verification process set in S702. When it is determined that the verification of any file subjected to the whole verification process is not completed, the process returns to S1001. When it is determined that the verification of all the files subjected to the whole verification process is completed, the process is terminated.

FIG. 11 is a flowchart illustrating procedures of the individual verification process in S712 in FIG. 7. When the individual verification process is started, an individual verification ongoing screen in including progress information of the individual verification process is displayed on the back-face display unit 28. As described above, the screen includes the cancel button 902 to instruct interruption of the individual verification process.

In FIG. 11, in S1101, the system controller 50 determines whether interruption of the individual verification process is instructed. When it is determined that the interruption of the individual verification process is instructed, that is, when the user presses the cancel button 902, the process ends. When it is determined that the interruption of the individual verification process is not instructed, the process proceeds to S1102.

In S1102, the system controller 50 updates the remaining time until completing the individual verification process. Accordingly, the user can understand the remaining time of the individual verification process. In addition, in the S 1102, information about a progress rate indicating a percentage of completion of the individual verification may be displayed on the individual verification ongoing screen in FIG. 9B in addition to the remaining time.

Next, the system controller 50 selects one moving image file from among the moving image files of which the verification result is NG or the moving image file set as the target file of the individual verification process in S711.

Then, in S1103, the system controller 50 verifies the signature value of the selected moving image file. The verification of the signature value in S1103 is performed in the same manner as S1003 described above. Then, in S1104, the system controller 50 determines whether the verification of the signature value is succeeded. The determination in S1104 is performed by the same method as that in S1004 described above. When it is determined that the verification of the signature value is not succeeded, the process proceeds to S1108 described later. When it is determined that the verification of the signature value is succeeded, the process proceeds to S1105.

In S1105, the system controller 50 compares the individual hash values of the selected moving image file. Specifically, the system controller 50 executes the hash function on the binary data of the GOPs of the moving image data 505' of the selected moving image file to generate a plurality of hash values corresponding to the respective GOPs. Then, the system controller 50 respectively compares the generated hash values with the hash values 527' that are hash values of the GOPs corresponding to the generated hash values and are hash values of the GOPs of the selected moving image file. This enables to verify presence or absence of falsification for each individual scene (GOP) included in the moving image data.

Then, in S1106, the system controller 50 determines whether the hash values match in all the comparisons in S1105. When it is determined that the hash values match in all the comparisons in S1105, the process proceeds to S1107. When it is determined that the hash values do not match in any of the comparisons in S1105, the process proceeds to S1108.

In S1107, the system controller 50 determines that the verification result of the selected moving image file is OK. Then, the process proceeds to S1109.

In S1108, the system controller 50 determines that the verification result of the selected moving image file is NG.

Then, in S1109, the system controller 50 updates the verification result. Based on the updated verification result, the information indicating the verification result (the number of verification OK scenes and the number of verification NG scenes) displayed on the individual verification ongoing screen in FIG. 9B is updated.

Next, in S1110, the system controller 50 determines whether a detail check is instructed. In the present embodiment, the user can instruct the detail check by pressing the detail check button 901 on the individual verification ongoing screen in FIG. 9B. When it is determined that the detail check is instructed, the process proceeds to S1111. When it is determine\d that the detail check is not instructed, the process proceeds to S1112.

In S1111, the system controller 50 displays a detail check screen in FIG. 9D on the back-face display unit 28. The detail check screen enables detail check of a verification NG scene. Then the process proceeds to S1112.

In the S1112, the system controller 50 determines whether the verifications of all the files subjected to the individual verification process are completed. All the files subjected to the individual verification process are the moving image files of which the verification result is NG or the moving image file set as the target file of the individual verification process in S711. When it is determined that the verification of any file subjected to the individual verification process is not completed, the process returns to S1101. When it is determined that the verifications of all the files subjected to the individual verification process are completed, the process is terminated.

According to the above-described embodiment, when falsification is detected in the whole verification process using the hash value generated by executing the hash function on the whole moving image data, it is controlled whether to execute the individual verification process using the plurality of hash values corresponding to the respective GOPs of the moving image data. That is, the execution of the individual verification process to verify in detail using a plurality of hash values is limited to a case where falsification of moving image data is detected. This reduces the time required for the verification process as compared to a configuration in which the individual verification process is performed on any moving image files, and improves the usability in the verification of moving image data.

In the above-described embodiment, the whole verification process is executed on files stored in a folder designated by a user. Accordingly, the user can designate the verification target in folder units instead of designating files one by one, and thus, the usability in the designation of the verification target is improved.

In the embodiment described above, the whole verification process detects falsification of moving image data included in a moving image file stored in a folder designated by a user, and further detects falsification of image data included in a still image file stored in the folder. Accordingly, in the whole verification process, the moving image files and still image files stored in the folder designated by the user can be verified at once.

In the above-described embodiment, the whole verification process is executed on a plurality of files that are stored in the folder designated by the user and satisfy the target conditions of the verification process designated by the user. Accordingly, the verification target of the whole verification process can be narrowed down to the file satisfying the target conditions of the verification process designated by the user among the files stored in the folder designated by the user, and the overall verification process can be performed only on the file intended by the user. As a result, the time required to complete the whole verification process can be reduced.

In the above-described embodiment, since the target conditions of the verifⁱcation process include the file fornat, the verification target of the total verifⁱcation process can be narrowed down to the files of the file format designated by the user.

In the above-described embodiment, since the target conditions of the verification process include the rating indicating the favorite level, the verification target of the whole verification process can be narrowed down to files of which the favorite level of the user is equal to or higher than a predetermined value.

In the above-described embodiment, when the completion prediction period of the individual verification process for all the moving image files of which the verification result is NG is equal to or less than the predetermined reference period, the individual verification process is executed. That is, the individual verification process is executed only when the period until completion is somewhat short. This prevents the individual verification process that takes an unexpected long period from being executed, and thus avoids a situation in which the user has to wait for a process that does not tell when it will end.

In the above-described embodiment, the auto-execution of the individual verification process, which is the function of always executing the individual verification process when falsification of moving image data is detected in the whole verification process, is set to valid or invalid in accordance with the instruction by the user. Accordingly, the user's intention can be reflected to the auto-execution of the individual verification process.

In the above-described embodiment, the auto-skipping of the individual verification process, which is the function of not executing the individual verifⁱcation process even when falsification is detected in the whole verifⁱcation process, is set to valid or invalid in accordance with the instruction by the user.

Accordingly, the user's intention can be reflected to the auto-skipping of individual verification process.

In the above-described embodiment, when falsification of moving image data is detected in the whole verification process, the user can select whether to execute the individual verification process. Accordingly, the user's intention can be reflected to whether the individual verification process is executed.

In the above-described embodiment, the user selects a moving image file subjected to the individual verification process. Accordingly, the user's intention can be reflected to the selection of the execution target of the individual verification process, and thus the time until completing the individual verification process can be reduced.

In the above-described embodiment, the information processing apparatus is the image capturing apparatus that generates a moving image file.

In the present embodiment, the items that can be set on the condition designation screen are not limited to the items shown in FIG. 8B. For example, the condition designation screen may further include an item to exclude a file obtained by the capturing of the digital camera 100 from the verification target, that is, an item to set the file obtained by the capturing or editing by an apparatus other than the digital camera 100 as the verification target. Accordingly, the verification target of the whole verification process can be narrowed down to the files obtained by the capturing or editing by the apparatus other than the digital camera 100.

In addition, although the digital camera is described as an example of the information processing apparatus in the present embodiment, the information processing apparatus is not limited to the digital camera. For example, the information processing apparatus may be a smartphone or a tablet terminal having an image capturing function. In addition, the information processing apparatus may be an apparatus such as a PC that obtains a moving image file captured or edited by another apparatus from the other apparatus and performs the verification process in FIG. 7 described above.

According to the present disclosure, the usability in the verification of falsification in moving image data is improved.

### Other Embodiments

[01981 Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above- described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or iBlu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024- 109453, filed July 8, 2024 which is hereby incorporated by reference herein in its entirety.

1. An information processing apparatus comprising:
a memory device that stores a set of instructions; and
at least one processor that executes the set of instructions to:
obtain a moving image file including moving image data constituted by frames, a first-type hash value generated by executing a hash function on whole moving image data when the moving image data is captured, and second-type hash values generated by executing the hash function on frame groups obtained by grouping the frames of the moving image data when the moving image data is captured;
execute a first process of detecting falsification of the moving image data by using the first-type hash value;
determine whether falsification of the moving image data is detected in the first process; and
control whether to execute a second process to detect falsification of the moving image data by using the second-type hash values when it is determined that falsification of the moving image data is detected in the first process.

2. The information processing apparatus according to claim 1, wherein the at least one processor executes instructions in the memory device to:
accept designation of a folder by a user; and
execute the first process on files stored in the folder designated by the user.

3. The information processing apparatus according to claim 2, wherein the at least one processor executes instructions in the memory device to detect falsification of moving image data included in a moving image file stored in the folder designated by the user and detect falsification of image data included in a still image file stored in the folder in the first process.

4. The information processing apparatus according to claim 2, wherein the at least one processor executes instructions in the memory device to:
accept designation of a condition to narrow down a file by the user; and
execute the first process on files that are stored in the folder designated by user and satisfy the condition.

5. The information processing apparatus according to claim 4, wherein the condition includes a file format.

6. The information processing apparatus according to claim 4, wherein the condition includes a rating indicating a favorite level.

7. The information processing apparatus according to claim 4 wherein the files include a file obtained by capturing or editing by an apparatus other than the information processing apparatus.

8. The information processing apparatus according to claim 1 that is an image capturing apparatus generating the moving image file.

9. The information processing apparatus according to claim 1, wherein the at least one processor executes instructions in the memory device to control so as to execute the second process in a case where a completion prediction period of the second process for all the moving image files of which falsification is detected in the first process is equal to or less than a predetermined reference period.

10. The information processing apparatus according to claim 1, wherein the at least one processor executes instructions in the memory device to set a function of always executing the second process when falsification of the moving image data is detected in the first process to be valid or invalid in accordance with an instruction by a user.

11. The information processing apparatus according to claim 1, wherein the at least one processor executes instructions in the memory device to allow a user to set a function of always skipping the second process when falsification of the moving image data is detected in the first process to be valid or invalid.

12. The information processing apparatus according to claim 1, wherein the at least one processor executes instructions in the memory device to accept a selection of a user to select whether to execute the second process when falsification of the moving image data is detected in the first process.

13. The information processing apparatus according to claim 1 wherein the at least one processor executes instructions in the memory device to accept a selection of a user to select a moving image file to be subjected to the second process.

14. The information processing apparatus according to claim 1, wherein the
at least one processor executes instructions in the memory device to present a completion prediction period of the first process and a completion prediction period of the second process.

15. A control method for an information processing apparatus, the control method comprising:
obtaining a moving image file including moving image data constituted by frames, a first-type hash value generated by executing a hash function on whole moving image data when the moving image data is captured, and second-type hash values generated by executing the hash function on frame groups obtained by grouping the frames of the moving image data when the moving image data is captured;
executing a first process of detecting falsification of the moving image data by using the first-type hash value;
determining whether falsification of the moving image data is detected in the first process; and
controlling whether to execute a second process to detect falsification of the moving image data by using the second-type hash values when it is determined that falsification of the moving image data is detected in the first process.

16. A non-transitory computer-readable storage medium storing a control program causing a computer to execute a control method for an information processing apparatus, the control method comprising:
obtaining a moving image file including moving image data constituted by frames, a first-type hash value generated by executing a hash function on whole moving image data when the moving image data is captured, and second-type hash values generated by executing the hash function on frame groups obtained by grouping the frames when the moving image data is captured;
executing a first process of detecting falsification of the moving image data by using the first-type hash value;
determining whether falsification of the moving image data is detected in the first process; and
controlling whether to execute a second process to detect falsification of
the moving image data by using the second-type hash values when it is determined that falsification of the moving image data is detected in the first process.
